(19) United States
(12) Patent Application Publication
(10) Pub. No.: US 2013/0091037 A1
(43) Pub. Date: Apr. 11, 2013

(54) CONTENT RESELLING METHOD AND CONTENT SELLING APPARATUS THEREFOR

(71) Applicants: Kyung-Chan CHA, Incheon (KR); Un-Hae CHOI, Anyang-si (KR); Yu-Ri HONG, Anyang-si (KR)

(72) Inventors: Kyung-Chan CHA, Incheon (KR); Un-Hae CHOI, Anyang-si (KR); Yu-Ri HONG, Anyang-si (KR)

(73) Assignee: KT CORPORATION, Seongnam-city (KR)

(21) Appl. No.: 13/523,540

(22) Filed: Jun. 14, 2012

(30) Foreign Application Priority Data
Oct. 10, 2011 (KR) 10-2011-0103123

(51) Int. Cl. G06Q 30/06

(52) U.S. Cl. 705/26.81

(57) ABSTRACT

Disclosed is a method for reselling contents registered in contents selling apparatus by a content reselling apparatus. The method includes: accessing the content selling apparatus based on reseller information of the content reselling apparatus; selecting at least one reselling content in which reselling is allowed from contents registered in the content selling apparatus; receiving and notifying information of the selected reselling content; receiving reselling content information which is requested to be purchased from a user terminal among the notified reselling contents; and transferring purchase request information of the to user terminal to the content selling apparatus.

### CROSS-REFERENCE TO RELATED APPLICATION

This application claims priority to and the benefit of Korean Patent Application No. 10-2011-0103123 filed in the Korean Intellectual Property Office on Oct. 10, 2011, the entire contents of which are incorporated herein by reference.

### BACKGROUND OF THE INVENTION

(a) Field of the Invention

The present invention relates a content reselling method and a content selling apparatus therefor.

(b) Description of the Related Art

According to the supply of smart phone, various applications executed in the smart phone have been actively developed. A developer registers developed applications in an application market which is a market for selling applications, and a smart phone user accesses the application market to download various applications. As illustrated above, the application market sells various contents with an application to a smart phone user, manages the application, and distributes a profit to the developer.

Because the application market up to now maintains and sells various contents as a centralized marketing channel, a user may unconditionally access the application market to purchase the contents. Accordingly, in the application market up to now, distribution and sales channels of contents are restrictive, and marketing and recommendation channels of the contents are also restrictive.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a content reselling method and a content selling apparatus therefor having advantages of reselling contents through a content reselling apparatus such as a web site to diversify selling and publication paths of a content selling apparatus.

An exemplary embodiment of the present invention provides a method for reselling contents registered in contents selling apparatus by a content reselling apparatus, the method including: accessing the content selling apparatus based on reseller information of the content reselling apparatus; selecting at least one reselling content in which reselling is allowed from contents registered in the content selling apparatus; receiving and notifying information of the selected reselling content; receiving content information which is requested to be purchased from a user terminal among the notified contents; and transferring purchase request information of the user terminal to the content selling apparatus.

The accessing of the content selling apparatus may include accessing the content selling apparatus based on an reseller identification of the content reselling apparatus issued by the content selling apparatus.

The transferring of the purchase request information may include transferring the purchase request information with the reseller identification.

The method may further include receiving distribution profit information corresponding to the seller identification from the content selling apparatus.

The content information which is requested to be purchased may include identification information of the user terminal and an identification of a content which is requested to be purchased from the user terminal.

The purchase request information may include the identification information of the user terminal, the identification of a content which is requested to be purchased, and a reseller identification corresponding to the content reselling apparatus.

The method may further include receiving purchase completion information of the user terminal from the content selling apparatus.

Another exemplary embodiment of the present invention provides a method for reselling contents by a content selling apparatus according to operative cooperation with a content reselling apparatus, the method including: registering the content reselling apparatus and issuing and providing a reseller identification to the content reselling apparatus; providing information of a content in which reselling is allowed to the content reselling apparatus accessed based on the reselling identification; receiving purchase request information of a user terminal from the content reselling apparatus having provided the information of the content in which reselling is allowed; determining whether the user terminal is a subscriber terminal subscribed in the content selling apparatus based on the purchase request information; and transmitting a content corresponding to the purchase request information to the user terminal by operative cooperation with the user terminal when the user terminal is the subscriber terminal.

The purchase request information may include the identification information of the user terminal, an identification of a content which is requested to be purchased from the user terminal, and a reseller identification corresponding to the content reselling apparatus.

The transmitting of the content to the user terminal may include performing a purchase processing of a content corresponding to the purchase request information and transmitting the content in which the purchase processing is completed to the user terminal.

The method may further include managing a selling history of reselling contents from the content reselling apparatus.

The information of the content in which reselling is allowed may include an identification and publication information of the content in which reselling is allowed.

Yet another exemplary embodiment of the present invention provides an apparatus for selling contents by operative cooperation with a content reselling apparatus, including: a reseller manger managing and authenticating a plurality of content reselling apparatuses; a reselling content manager managing a content in which reselling is allowed and providing reselling content information to a content reselling apparatus in which reselling is authenticated; and a user terminal cooperator receiving purchase request information of a user terminal from the content reselling apparatus having provided the reselling content information, and transmitting a content which is requested to be purchased from the user terminal to the user terminal by operative cooperation with the user terminal based on the received purchase request information of the user terminal.

The reselling content information may include an identification and publication information of a reselling content.

The purchase request information of the user terminal may include the identification information of the user terminal, an identification of a content which is requested to be purchased from the user terminal, and an identification of the content reselling apparatus.

The user terminal cooperator may perform a purchase processing of a content corresponding to a content identification which the user terminal requests a purchase, and transmit the content which the purchase processing is completed to the user terminal.

The reseller manager may transfer at least one of purchase completion information and distribution profit information of the user terminal to the content reselling apparatus.

An exemplary embodiment of the present invention may diversify sale and publication paths of a content selling apparatus to a content reselling apparatus such as an external web site, and distribute a profit to the content reselling apparatus to activate a sale and publication of the contents.

### BRIEF DESCRIPTION OF THE DRAWINGS

FIG. 1 is a block diagram schematically illustrating a content selling system according to an exemplary embodiment of the present invention.

FIG. 2 is a flowchart illustrating a content reselling method according to an exemplary embodiment of the present invention.

FIG. 3 is a flowchart illustrating a content reselling method according to another exemplary embodiment of the present invention.

FIG. 4 is a flowchart illustrating a content reselling method according to yet another exemplary embodiment of the present invention.

FIG. 5 is a block diagram illustrating a content reselling apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout specification, unless explicitly described to the contrary, the word “comprise” and variations such as “comprises” or “comprising”, will be understood to imply the inclusion of stated elements but not the exclusion of any other elements.

Hereinafter, a content reselling method and a content selling apparatus therefor according to an exemplary embodiment of the present invention will be described in detail with reference to the accompanying drawings.

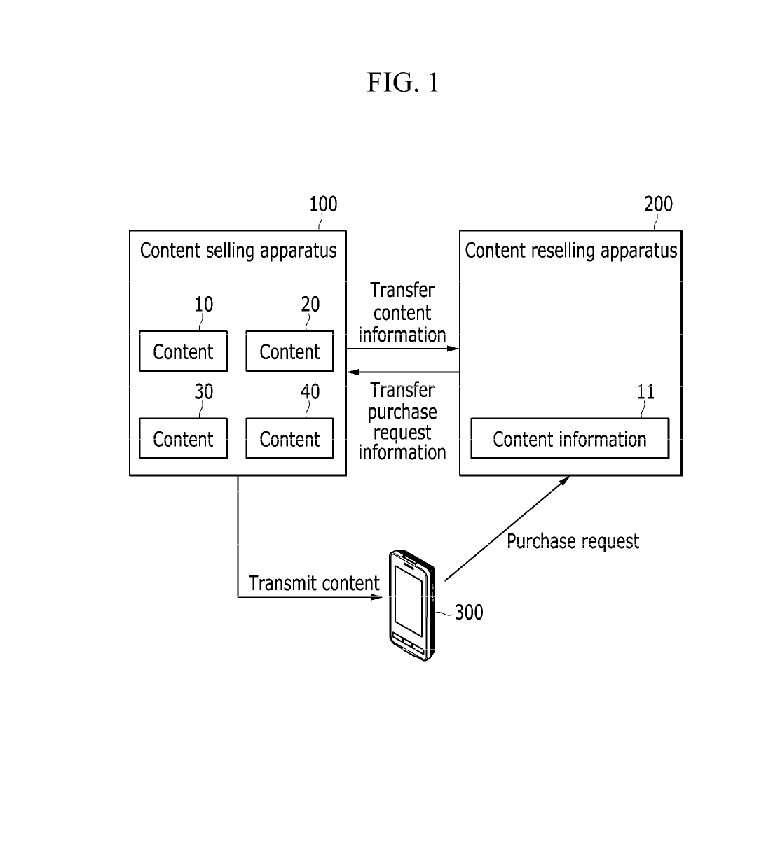

FIG. 1 is a block diagram schematically illustrating a content selling system according to an exemplary embodiment of the present invention.

Referring to FIG. 1, a content selling system includes a content selling apparatus 100, a content reselling apparatus 200, and a user terminal 300. The user terminal 300 accesses the content selling apparatus 100 or the content reselling apparatus 200 to download a digital content therefrom. Here, the content generally refers to digital goods which is manufactured and transmitted in a digital form such as applications, moving images, music, images, documents, and the like.

The content selling apparatus 100 stores various contents 10, 20, 30, and 40, and sells paid contents. The user terminal 300 purchases contents sold from the content selling apparatus 100 to use the purchased contents. The content selling apparatus 100 may put up contents registered from a content developer, and sell the registered contents to the user terminal 300, and then distribute a predetermined profit to the content developer. The content selling apparatus 100 may be called an application market, an application store, or the like.

The content selling apparatus 100 may enable the content reselling apparatus 200 to resell a part of the contents. To do this, the content selling apparatus 100 transmits reselling content information requested from the content reselling apparatus 200, and transmits a reselling content to a user terminal 300 having requested a purchase via the content reselling apparatus 200. In this case, the content selling apparatus 100 make only a content reselling apparatus 200 registered in the content selling apparatus 100 to resell contents.

The content reselling apparatus 200 resells contents sold from the content selling apparatus 100. The content reselling apparatus 200 fetches reselling content information, for example, information 11 of the content 10 from the content selling apparatus 100, and posts the fetched reselling content information on a web page or the like. Further, if the user terminal 300 requests purchasing of the posted reselling content, the content reselling apparatus 200 transmits purchase request information to the content selling apparatus 100 in which a reselling content 10 is actually stored. The content selling apparatus 100 having received the purchase request information communicates with the user terminal 300 based on the purchase request information and transmits the content 10 to the user terminal 300. When transmitting the purchase request information of the user terminal 300 to the content selling apparatus 100, the content reselling apparatus 200 may transmit its reseller identification together therewith. Here, the content reselling apparatus 200 generally refers to a device capable of notifying a reselling content in a web page including a blog or a micro blog, a web site, a social network site (SNS), and an application which the user terminal 300 may access to.

Here, the content reselling apparatus 200 may not only resell paid contents but also notify and advertise free contents. That is, the content reselling apparatus 200 may notify promotional contents such that the user terminal 300 selects the contents. When the content reselling apparatus 200 notifies the free contents, the content selling apparatus 100 may transmit corresponding contents to the user terminal 300 without payment process.

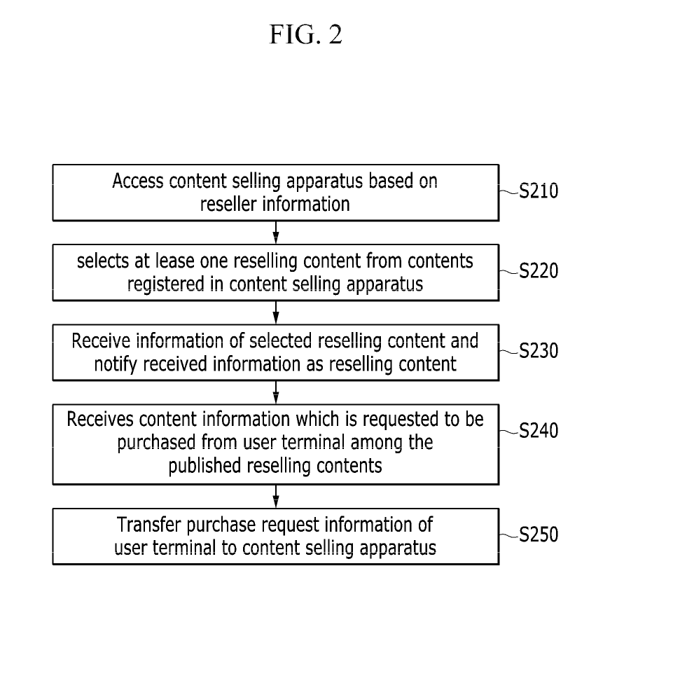

FIG. 2 is a flowchart illustrating a content reselling method according to an exemplary embodiment of the present invention.

Referring to FIG. 2, a content reselling apparatus 200 operatively cooperates with a content selling apparatus 100 to resell contents of the content selling apparatus 100.

The content reselling apparatus 200 accesses the content selling apparatus 100 based on reseller information (S210). The content reselling apparatus 200 is registered in the content selling apparatus 100 as a reseller, and receives a reseller identification issued from the content selling apparatus 100. Next, the content reselling apparatus 200 uses reseller information including a reseller identification to access the content selling apparatus 100.

The content reselling apparatus 200 selects at least one reselling content from contents registered in the content selling apparatus 100 (S220).

The content reselling apparatus 200 receives information of the selected reselling content and notifies the received information as a reselling content (S230). When the reseller identification is valid and reselling of the selected reselling content is allowed, the content reselling apparatus 200 receives information of the reselling content from the content selling apparatus 100. The information of the reselling content includes an identification of the reselling content and publication information which the content reselling apparatus 200 may publish in a web page. For example, when the content reselling apparatus 200 publishes reselling contents on a web page, the content selling apparatus 100 may provide content information for a web page including images or the like to the content reselling apparatus 200. When the content reselling apparatus 200 publishes the reselling contents in a social network service, the content selling apparatus may provide address (URL) information hyperlinked to the page having details of the contents to the content reselling apparatus 200. Further, the content selling apparatus 100 may provide details of the reselling contents or a details connection page such that the user terminal 300 may also confirm the details of the reselling contents on the web page managed by the content reselling apparatus 200.

The content reselling apparatus 200 receives content information which is requested to be purchased from the user terminal 300 among the published reselling contents (S240). The content information which is requested to be purchased contains terminal identification information and an identification of a content which is requested to be purchased.

The content reselling apparatus 200 transfers purchase request information of the user terminal 300 to the content selling apparatus 100 (S250). The purchase request information of the user terminal contains terminal identification information, the identification of the content which is requested to be purchased, and a reseller identification corresponding to the content selling apparatus 200. The content selling apparatus 100 having received the purchase request information of a user terminal 100 operatively cooperates with the user terminal 100 to perform a purchase processing of the user terminal 100.

Next, the content reselling apparatus 200 may receive purchase completion information of the user terminal 100 from the content selling apparatus 100. Further, the content reselling apparatus 200 may receive distribution profit information from the content selling apparatus 100.

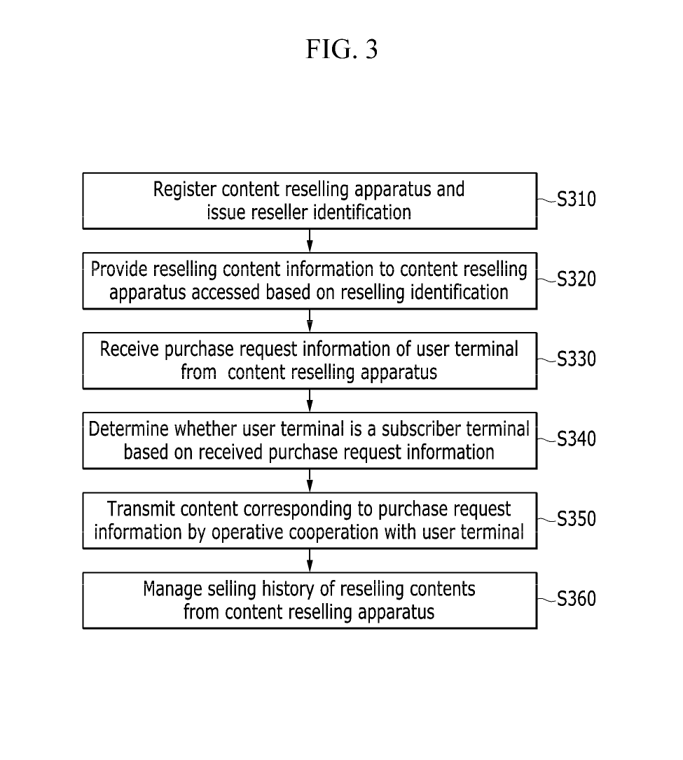

FIG. 3 is a flowchart illustrating a content reselling method according to another exemplary embodiment of the present invention.

Referring to FIG. 3, a content selling apparatus 100 operatively cooperates with a content reselling apparatus 200 to purchase contents.

The content selling apparatus 100 registers the content reselling apparatus 200 and issues a reseller identification (S310).

The content selling apparatus 100 provides reselling content information to a content reselling apparatus 200 accessed based on the reselling identification (S320). The reselling content information includes an identification of a reselling content and publication information which the content reselling apparatus 200 may publish.

The content selling apparatus 100 receives purchase request information of the user terminal 300 from the content reselling apparatus 200 (S330). The purchase request information of the user terminal 300 contains terminal identification information, an identification of a content which is requested to be purchased, and a reseller identification corresponding to the content reselling apparatus 200.

The content selling apparatus 100 determines whether the user terminal 300 is a subscriber terminal subscribed in the content selling apparatus 100 based on the received purchase request information (S340). The content selling apparatus 100 identifies a user of the user terminal 300 based on the subscriber's information, and then performs purchase process such as a settlement when the user terminal 300 is the subscriber terminal. When the user terminal 300 is not the subscriber terminal, the content selling apparatus 100 may provide subscription screen to the user terminal 300.

When the user terminal 300 is the subscriber terminal, the content selling apparatus 100 operatively cooperates with the user terminal 300 to transmit a content corresponding to the purchase request information to the user terminal 300 (S350). When the content corresponding to the purchase request information is a paid content, the content selling apparatus 100 performs a purchase processing. When the purchase processing is completed, the content selling apparatus 100 transmits the content to the user terminal 300.

There may be various methods that the user terminal 300 downloads a to reselling content notified by the content reselling apparatus 200 from the content selling apparatus 100. For example, the content selling apparatus 100 may send a settlement request message to the user terminal 300 based on purchase request information of the user terminal 300 received from the content reselling apparatus 200. When the user terminal 300 completes the settlement of the content, the content selling apparatus 100 transmits the content requested to be purchased to the user terminal 300. Meanwhile, the content selling apparatus 100 may ask the user terminal 300 whether the user terminal 300 will purchase a reselling content which is requested to be purchased from the content reselling apparatus 200. Then, the user terminal 300 determines whether the reselling content which is requested to be purchased has been previously stored. When the content which is requested to be purchased has been previously stored, the user terminal 300 may confirm the version of the content, and then finally determine whether the purchasing is needed.

The content selling apparatus 100 manages a selling history of reselling contents from the content reselling apparatus 200 (S360). According to this, the content selling apparatus 100 may distribute a profit to the content reselling apparatus 200.

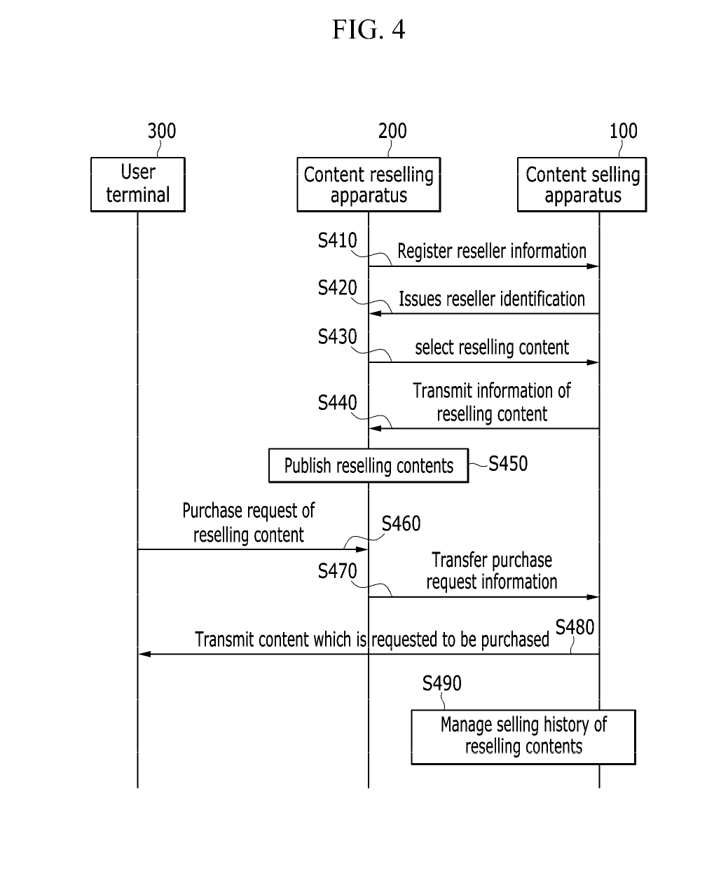

FIG. 4 is a flowchart illustrating a content reselling method according to yet another exemplary embodiment of the present invention.

Referring to FIG. 4, a content reselling apparatus 200 registers reseller information in a content selling apparatus 100 (S410).

The content selling apparatus 100 issues and provides a reseller identification to the content reselling apparatus 200 (S420).

The content reselling apparatus 200 accesses the content selling apparatus 100 based on the reseller identification to select at least one reselling content (S430).

The content selling apparatus 100 transmits information of the reselling contents to the content reselling apparatus 200 (S440).

The content reselling apparatus 200 publishes reselling contents (S450).

The content reselling apparatus 200 receives a purchase request of the reselling content from the user terminal 300 (S460).

The content reselling apparatus 200 transfers purchase request information from the user terminal 300 to the content selling apparatus 100 (S470).

When the user terminal 300 is a subscriber terminal, the content selling apparatus 100 operatively cooperates with the user terminal 300 to transmit a content which is requested to be purchased to the user terminal 300 (S480).

The content selling apparatus 100 manages a selling history of reselling contents from the content reselling apparatus 200 (S490).

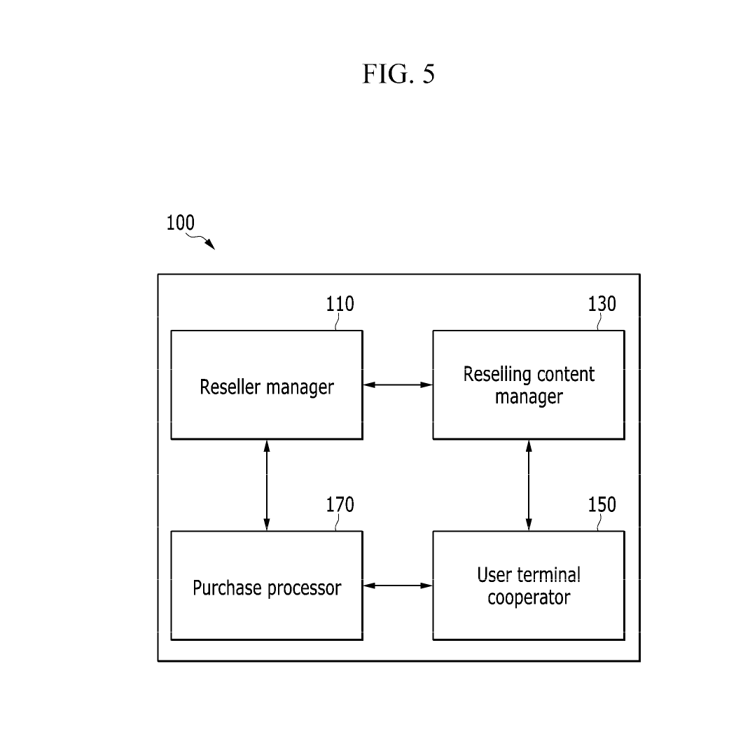

FIG. 5 is a block diagram illustrating a content reselling apparatus according to an exemplary embodiment of the present invention.

Referring to FIG. 5, a content selling apparatus 100 operatively cooperates with a content reselling apparatus 200 to purchase contents. The content selling apparatus 100 includes a reseller manager 110, a reselling content manager 130, and a user terminal cooperator 150. The content selling apparatus 100 further includes a purchase processor 170 for performing purchase processing such as a settlement or billing. As illustrated above, the content selling apparatus 100 is a device that may publish a reselling content in a web page including a blog or a micro blog, a web site, a social network site (SNS), an application that the user terminal 300 may access to.

The reseller manager 110 manages and authenticates a plurality of content reselling apparatuses. The reseller manager 110 issues a reseller identification corresponding to each content reselling apparatus. The reseller manager 110 may transfer at least one of purchase completion information and distribution profit information to a content reselling apparatus having resold contents.

The reselling content manager 130 manages the reselling content and provides reselling content information to an authenticated content reselling apparatus. The reselling content information contains an identification and publication information of a reselling content.

The user terminal cooperator 150 operatively cooperates with the user terminal 300 to transmit a content which is requested to be purchased from the user terminal 300 to the user terminal 300, based on purchase request information received from an optional content reselling apparatus, for example, a content reselling apparatus 200 of a plurality of content reselling apparatuses. The purchase request information of the user terminal 300 contains user terminal identification information, an identification of a content which is requested to be purchased, and an identification of a content reselling apparatus. The user terminal cooperator 150 determines whether the user terminal 300 is a subscriber terminal subscribed in the content selling apparatus 100. When the user terminal 300 is the subscriber terminal, the user terminal cooperator 150 to may operatively cooperate with the user terminal 300 to transmit a content which is requested to be purchased to the user terminal 300. When the content which is requested to be purchased from the user terminal 300 is a paid content, the user terminal cooperator 150 operatively cooperates with the purchase processor 170 to perform a purchase processing. The user terminal cooperator 150 may transmit a content whose the purchase processing is completed to the user terminal 300.

An exemplary embodiment of the present invention may diversify selling and publication paths of a content selling apparatus 100 to the content reselling apparatus 200 such as an external web page or like. Further, the exemplary embodiment of the present invention may distribute a profit to the content reselling apparatus 200 to activate a selling and publication of the contents.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for reselling contents registered in contents selling apparatus by a content reselling apparatus, the method comprising:
accessing the content selling apparatus based on reseller information of the content reselling apparatus;
selecting at least one reselling content in which reselling is allowed from contents registered in the content selling apparatus;
receiving and notifying information of the selected reselling content;
receiving content information which is requested to be purchased from a user terminal among the notified contents; and
transferring purchase request information of the user terminal to the content selling apparatus.

2. The method of claim 1, wherein:
the accessing of the content selling apparatus
includes accessing the content selling apparatus based on an reseller identification of the content reselling apparatus issued by the content selling apparatus.

3. The method of claim 2, wherein:
the transferring of the purchase request information includes
transferring the purchase request information with the reseller identification.

4. The method of claim 2, further comprising:
receiving distribution profit information corresponding to the seller identification from the content selling apparatus.

5. The method of claim 1, wherein:
the content information which is requested to be purchased includes
identification information of the user terminal and an identification of a content which is requested to be purchased from the user terminal.

6. The method of claim 5, wherein:
the purchase request information includes
the identification information of the user terminal, the identification of a content which is requested to be purchased, and a reseller identification corresponding to the content reselling apparatus.

7. The method of claim 1, further comprising:
receiving purchase completion information of the user terminal from the content selling apparatus.

8. A method for reselling contents by a content selling apparatus according to cooperation operatively with a content reselling apparatus, the method comprising:
registering the content reselling apparatus and issuing a reseller identification to the content reselling apparatus;
providing information of a content in which reselling is allowed to the content reselling apparatus accessed based on the reselling identification;
receiving purchase request information of a user terminal from the content reselling apparatus having provided the information of the content in which reselling is allowed;
determining whether the user terminal is a subscriber terminal subscribed in the content selling apparatus based on the purchase request information; and
transmitting a content corresponding to the purchase request information to the user terminal by operative cooperation with the user terminal when the user terminal is the subscriber terminal.

9. The method of claim 8, wherein:
the purchase request information includes
the identification information of the user terminal, an identification of a content which is requested to be purchased from the user terminal, and a reseller identification corresponding to the content reselling apparatus.

10. The method of claim 8, wherein:
the transmitting of the content the user terminal
includes performing a purchase processing of the content corresponding to the purchase request information and transmitting the content in which the purchase processing is completed to the user terminal.

11. The method of claim 8, further comprising:
managing a selling history of reselling contents from the content reselling apparatus.

12. The method of claim 8, wherein:
the information of the content in which reselling is allowed includes
an identification and publication information of the content in which reselling is allowed.

13. An apparatus for selling contents by operative cooperation with a content reselling apparatus, comprising:
a reseller manger managing and authenticating a plurality of content reselling apparatuses;
a reselling content manager managing a content in which reselling is allowed and providing reselling content information to a content reselling apparatus in which reselling is authenticated; and
a user terminal cooperator receiving purchase request information of a user terminal from the content reselling apparatus having provided the reselling content information, and transmitting a content which is requested to be purchased from the user terminal to the user terminal by operative cooperation with the user terminal based on the received purchase request information of the user terminal.

14. The apparatus of claim 13, wherein:
the reselling content information includes an identification and publication information of a reselling content.

15. The apparatus of claim 13, wherein:
the purchase request information of the user terminal includes
the identification information of the user terminal, an identification of a content which is requested to be purchased from the user terminal, and an identification of the content reselling apparatus.

16. The apparatus of claim 15, wherein:
the user terminal cooperator
performs a purchase processing of a content corresponding to a content identification which the user terminal requests a purchase, and transmits the content which the purchase processing is completed to the user terminal.

17. The apparatus of claim 16, wherein:
the reseller manager
transfers at least one of purchase completion information and distribution profit information of the user terminal to the content reselling apparatus.
